(19) United States
(12) Patent Application Publication
(10) Pub. No.: US 2012/0017718 A1
(43) Pub. Date: Jan. 26, 2012

(54) ROBOTIC MUSCULAR-SKELETAL JOINTED STRUCTURES

(75) Inventor: Richard Martin Greenhill, London (GB)

(73) Assignee: THE SHADOW ROBOT COMPANY LIMITED, London (GB)

(21) Appl. No.: 13/201,434

(22) PCT Filed: Jan. 27, 2010
(86) PCT No.: PCT/GB2010/000127

§ 371 Date: Oct. 14, 2011

(30) Foreign Application Priority Data
Feb. 13, 2009 (GB) 0902382.1

(51) Int. Cl. B25J 17/00; F16J 10/00; B25J 18/00

(52) U.S. Cl. 74/490.05; 92/169.1; 901/28; 901/22

(57) ABSTRACT

A robotic musculo-skeletal jointed structure comprising: (a) first and second joint parts coupled together for relative angular movement about a hinge axis there between; (b) an air muscle; (c) spaced first and second attachment sites, being sites respectively located at said joint first and second parts, and about which the tubular braiding, at least, of said air muscle extends to form an endless loop; (d) first and second attachment means respectively located at said first and second air muscle spaced attachment sites, said first attachment means being such as to secure said tubular braiding against lengthwise movement thereof with respect to said joint first part at said first attachment site, and said second attachment means being such as to secure said tubular braiding against lengthwise movement thereof with respect to said joint second part at said second attachment site, the endless tubular braiding being thereby partitioned into first and second tubular braiding segments contiguous with one another at both said attachment sites and housing segregated first and second resiliently expansible tubular parts, respectively; and, (e) air duct means, being means whereby air may be admitted and evacuated, as may be required, independently to and from said resiliently expansible air muscle tubular parts; and in which: (f) said joint parts, the location there between of said axis, the locations of said first and second attachment sites and of said first and second tubular braiding attachment means thereat, and the positional inter-relationship between all of these, are such that change in tubular braiding length arising from variation in girth of the resiliently expansible tubular parts under change in air pressure in said air muscle tubular parts, or either of them, gives rise to a corresponding angular relative displacement between said joint first and second parts about said axis.

### FIELD

This invention relates to robotic musculo-skeletal jointed structures of novel form and to hand/arm configurations incorporating such jointed structures.

### BACKGROUND

An air muscle comprises, as is well known in the art, a length of tubular braiding, commonly of a cross-weave construction; within said tubular braiding length, tube composed of a resiliently expansible material, notably rubber; and, leading to the interior of the tube, air ducting. Under air admitted, under pressure, to the interior of said air-tight tube by way of air dueling, the tube is caused to expand, increase in girth of the tube causing the tubular braiding, also, to expand, deformation of the tubular braiding in consequence of such expansion, causing a shortening in its length. The tubular braiding is adapted to be coupled, commonly by artificial tendon to a part, such, for example, as a lever arm, to be moved, the shortening in length, as aforesaid, of the tubular braiding being employed to cause such movement in the coupled part. At evacuation of air from the tube, consequent contraction in girth of the tube frees the tubular braiding for extension under effort derived from a return spring or from a second air muscle envelope acting on the attached part antagonistically to the first mentioned air muscle.

### SUMMARY

According to the invention, a robotic musculo-skeletal jointed structure comprises:

(a) first and second joint parts coupled together for relative angular movement about a hinge axis therebetween;

(b) an air muscle;

(c) spaced first and second attachment sites, being sites respectively located at said joint first and second parts, and about which the tubular braiding, at least, of said air muscle extends to form an endless loop;

(d) first and second attachment means respectively located at said first and second air muscle spaced attachment sites, said first attachment means being such as to secure said tubular braiding against lengthwise movement thereof with respect to said joint first part at said first attachment site, and said second attachment means being such as to secure said tubular braiding against lengthwise movement thereof with respect to said joint second part at said second attachment site, the endless tubular braiding being thereby partitioned into first and second tubular braiding segments contiguous with one another at both said attachment sites and housing segregated first and second resiliently expansible tubular parts, respectively; and,

(e) air duct means, being means whereby air may be admitted and evacuated, as may be required, independently to and from said air muscle compartments; and in which:

(f) said joint parts, the location therebetween of said axis, the locations of said first and second attachment sites and of said first and second air muscle envelope tubular braiding attachment means thereat, and the positional inter-relationship between all of these, are such that change in tubular braiding length arising from variation in girth of the resiliently expansible tube of the air muscle envelope under change in air pressure in said air muscle compartments, or either of them, gives rise to a corresponding angular relative displacement between said joint first and second parts about said axis.

Robotic musculo-skeletal jointed structures as stated above represent an improvement over prior art jointed structures of the form briefly hereinbefore described. Firstly, the elimination of all closure members, headers, for the resiliently expansible tubular parts within the tubular braiding, and the endless looped form of the tubular braiding itself enables the tubular braiding segments and the muscle parts therewithin to be longer, and the torque capable of being developed between the first and second joint parts, in consequence, than has previously been the case.

The expansible first and second tubular parts respectively residing within the tubular braiding segments may be individual parts each sealed at both ends. Preferably, however, the joint comprises an endless resiliently expansible tube housed within the endless tubular braiding, and a clamp arrangement which effects closure of the first and second tubular parts at location at which said tubular braiding is clamped, thereby to partition the endless tube thereby to create first and second segments containing segregated first and second air compartments housed respectively within said first and second tubular braiding segments.

The joint second part may comprise a second hinge axis, being the longitudinal axis of a second shaft and being contained in a plane other than that in which the first hereinbefore mentioned hinge axis is contained, and pulley means mounted on said second shaft, being pulley means rotatable about said second hinge axis; and in such construction, the central space within said endless tubular braiding is occupied, at least in part, by two further air muscles, being air muscles comprising individual tubular braidings and, within said tubular braidings, resiliently expansible tubes end-stopped at headers; and
tubular braiding end portions of said two further air muscles are connected to one another by filamentous material extending tautly around said pulley means from one sheath end portion to the other.

According to the invention, also, a musculo-skeletal jointed structure combination comprises first and second joints, each as stated in the last preceding paragraph, the joint first parts of said first and second joints being united at a common interface position with the joint first parts orientated through 180 degrees with respect to one another. The common interface position may be provided by the face to face contact between said first and second joints at surfaces of beam members of said joints. Alternatively the first and second joints may share a common beam member, this constituting the interface between the first and second joints.

According to the invention, also, a robotic hand/arm configuration comprises an air muscle driven humerus-representing part adapted to be coupled to a torso-representing part for angular displacement of the humerus-representing part with respect to a torso-representing part; an electric actuator driven fore-arm-representing part coupled for angular motion with respect to said humerus-representing element; a hand representing part of coupled to said fore-arm representing part at a wrist-representing joint; and tendon-representing filamentous material coupling the said wrist and the finger-representing joints of said hand-representing part variously to the several electric actuators of said fore-arm representing part. Preferably, the torso-representing part, the humerus-representing part, and the forearm-representing part are coupled as aforesaid by a musculo-skeletal joint combination as described in the last preceding paragraph.

According to one embodiment of the invention a fluid actuated muscle is provided. The fluid actuated muscle comprising: an continuous expandable tube comprising a first chamber and a second chamber; chamber defining devices defining the first chamber and the second chamber, such that fluid cannot be transferred between the first chamber and the second chamber; and a fluid inlet/outlet device configured to enable fluid inlet/outlet to/from the first chamber and fluid inlet/outlet to/from the second chamber.

According to another embodiment of the invention the fluid actuated muscle further comprises: a braided layer surrounding the expandable tube.

According to another embodiment of the invention at least one chamber defining device comprises the fluid inlet/outlet device.

According to another embodiment of the invention the fluid inlet/outlet device comprises a curved surface, and wherein the expandable tube follows the curvature of at least a portion of the curved surface.

According to another embodiment of the invention the chamber defining devices comprise a curved surface, and wherein the expandable tube follows the curvature of at least a portion of the curved surface.

According to another embodiment of the invention the chamber defining devices comprise a clamp.

According to another embodiment of the invention the expandable tube comprises an elastomeric material.

According to another embodiment of the invention the expandable tube comprises natural rubber.

According to another embodiment of the invention the braided layer comprises a lattice of interconnected flexible monofilament with low elasticity strands

According to another embodiment of the invention radial expansion of the braided layer results in contraction of the depth of the braided layer.

According to another embodiment of the invention the fluid is air.

According to another embodiment of the invention the fluid inlet/outlet device comprises a first fluid inlet/outlet configured to enable fluid inlet/outlet to/from the first chamber and a second fluid inlet/outlet configured to enable fluid inlet/outlet to/from the second chamber.

According to one embodiment of the invention a robotic limb comprising a fluid actuated muscle of the invention is provided.

### DESCRIPTION OF THE DRAWINGS

For a better understanding of the invention and to show how the same may be carried into effect, reference will now be made by way of example to the accompanying drawings:

FIG. 1 is a side view of a robotic musculo-skeletal jointed structure with part of a one beam member of a joint first part removed;

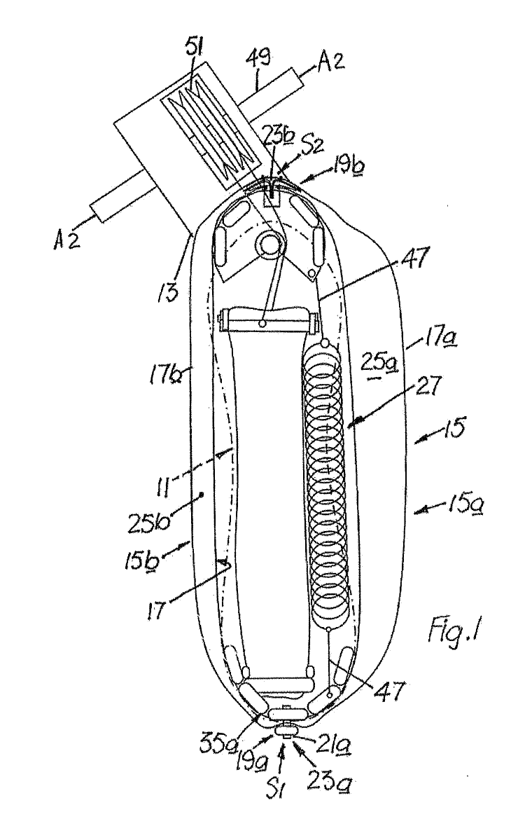

FIG. 2 shows a frontal view of the joint first part of FIG. 1 with a first segment of the endless air muscle removed;

FIG. 3 shows a frontal view at the opposite face of the joint first part of FIGS. 1 and 2 with the other segment of endless air muscle removed;

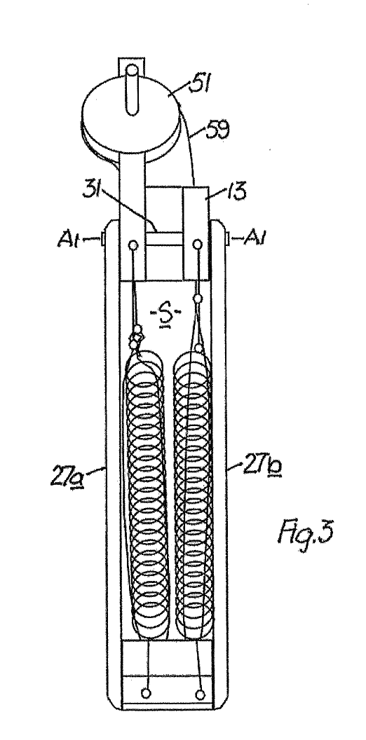

FIG. 4 shows a frontal view of the joint first parts of a combination comprising two jointed structures each as depicted in FIGS. 1 to 3 with corresponding said first segments of the endless air muscle removed;

FIG. 5 shows frontal view of the jointed structure combination of FIG. 4 but with the first segment of the endless air muscle of the left-hand joint only removed;

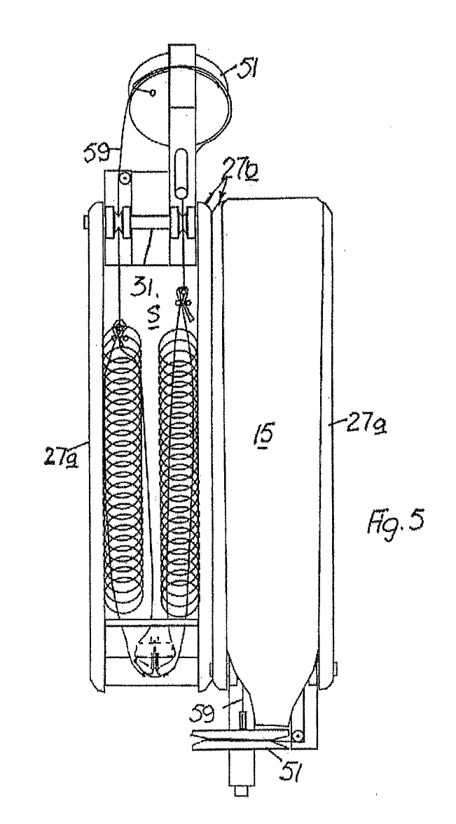

FIG. 6 shows a detail of the jointed structure of FIGS. 1 to 3; and

FIG. 7 shows a robotic hand/arm configuration employing inter alia the combination depicted in FIG. 4.

### DETAILED DESCRIPTION

Embodiments of the invention will now be described, by way of example only, with reference to the accompanying drawings.

Broadly, a robotic musculo-skeletal jointed structure in accordance with the invention comprises:

(a) first and second joint parts 11, 13, coupled together for relative angular movement about a hinge axis A1-A1 therebetween;

(b) air muscle means 15;

(c) spaced first and second attachment sites S1, S2, being sites respectively located at said joint first and second parts 11, 13, and about which the tubular braiding 17 of the air muscle means 15 extends such as to form an endless loop;

(d) first and second attachment means 19a, 19b, respectively located at the first and second air muscle spaced attachment sites S1, S2, the first attachment means 19a being such as to secure the tubular braiding 17 against lengthwise movement thereof with respect to said joint first part 11 at said first attachment site S1, and the second attachment means 19b being such as to secure the tubular braiding 17 against lengthwise movement thereof with respect to the joint second part 13 at the second attachment site S2, the endless looped tubular braiding 17 being thereby partitioned into first and second tubular braiding segments 17a, 17b, contiguous with one another at both said attachment sites S1, S2 and housing segregated first and second resiliently expansible air muscle tubular parts 15a, 15b, respectively, of the air muscle means; and,

(e) air duct means 23b, being means whereby air, or another suitable fluid, may be admitted and evacuated, as may be required, independently to and from said resiliently expansible tubular parts 15a, 15b; and

(f) the joint parts 11, 13, the location therebetween of the axis A1-A1, the locations of said first and second attachments sites S1, S2, and of said first and second tubular braiding attachment means 19a, 19b, thereat, and the positional inter-relationship between all of these, are such that change in the length of the tubular braiding segments 17a 17b or either of them, arising from variation in girth of the resiliently expansible tubular parts 15a, 15b under change in air pressure in said tubular parts, or either of them, gives rise to a corresponding angular relative displacement between the joint first and second parts 11, 13, about the axis A1-A1. It will be noted, from the foregoing, that in, its broad terms, the form of the resiliently expansible tubular component of the air muscle means 15 is left undefined, and the character of the air duct means 23b is defined only functionally. The tubular component of the air muscle means 15 might, for example, comprise first and second individual resiliently expansible air muscles housed respectively within the tubular braiding segments 17a, 17b, respectively, of a common endless tubular braiding 17, looped as stated. It might, alternatively, comprise a single resiliently expansible tube one portion of which extends from the tubular braiding attachment site S1 into one segment 15a of the endless looped tubular braiding 15, and a second portion of which extends from the tubular braiding attachment site S1 into the other segment 15b of the endless looped tubular braiding from the tubular braiding attachment site S1, also.

As for that air duct means 23b, this might comprise any of a variety of arrangements, the most obvious being the provision of individual air duct devices, one for each resiliently expansible tubular component.

In the example, however, the joint comprises: an endless resiliently expansible tube housed within the endless tubular braiding 17; and first and second clamping arrangements 23a, 23b, respectively, these effecting sealing closures of said endless tube at the locations of the attachment means 19a, 19b, by which the tubular braiding 17 is attached to the joint first and second parts 11, 13, thereby to partition the endless tube such as to create the first and second resiliently expansible tubular parts 15a, 15b, as tubular segments housed, respectively, within the first and second tubular braiding segments 17a, 17b, with the first and second air compartments 25a, 25b, respectively, of said tubular segments segregated against the migration of air therebetween.

The tubular braiding 17 may comprise a lattice of interconnected strands of any flexible monofilament with low elasticity. The following are example of braiding layer 17 materials: nylon; polyethylene terephthalate (polyester); fibreglass sleeving; stainless steel; metallic mylar; chrome expandable braiding; kevlar; polyphenylene sulphide (ryton); perfluoroalkoxy (teflon); and ethylene-chlorotrifluoroethylene.

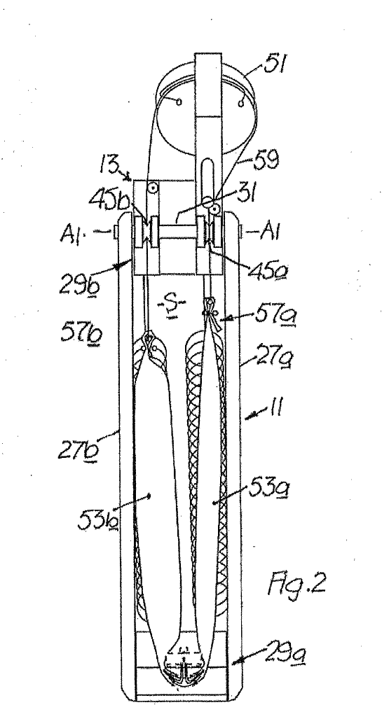

In the example, the joint first part 11 illustrated in FIG. 2 comprises first and second beam members 27a, 27b; means 29a, 29b, supporting the beam members 27a, 27b, such that these are held spaced apart with their longitudinal directions parallel to one another; bridging the space S between said beam members 27a, 27b, transversely, a shaft 31 the longitudinal axis of which constitutes the hinge axis A1-A1 between the first and second parts 11, 13.

The joint second part 13 is attached to the shaft 31 such as to be freely angularly movable with respect to said beam structure about the hinge axis A1-A1. In the example, the shaft 31 is fixed to the beam members 27a, 27b, at its ends, and the joint second part 13 is rotatable with respect to the shaft 31.

The tubular braiding attachment sites S1, S2, respectively located at first and second parts 33a, 33b, of the joint first and second parts 11, 13, have first and second singly-substantially convexly-curved surfaces 35a, 35b, respectively, around which the looped endless tubular braiding 17 extends, in contact with said surfaces.

The singly-convexly curved surfaces 35a, 35b, are of substantially cylindrical form, and whilst, preferably, the curved surfaces 35a, 35b are smoother uninterrupted surfaces of a unitary part, a plastic moulding or a milled metal part, perhaps, the expression “convexly curved” is to be given a somewhat broader scope including, as in the parts depicted, an arrangement of slat members supported edge to edge around path singly-curved path.

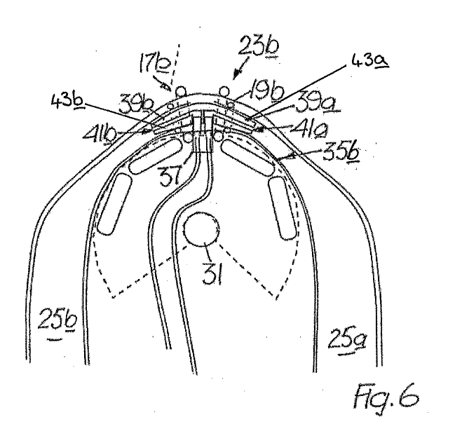

The air duct means 23b, as illustrated in FIG. 6, is of a unitary construction, having a central stem portion 37 located at the joint second part 13 within an opening located centrally along the single convexly-curved surface 35a in the direction of curvature thereof; and first and second arm portions 39a, 39b, extending, in said direction of curvature, from said stem portion 37 at either side thereof, and first and second separate air passages 41a, 41b, respectively, extend through the air duct means, the first 41a through central stem portion 37 and said first arm portion 39a, the second 41b through the stem portion 37 and the second arm portion 39b.

The term continuous means that the expandable tube is formed of one piece of tube. The endless resiliently expansible tube is formed of a plain length of tube together with the arm portions 39a, 39b of said air duct means 23b, the air duct means 23b having its first arm portion 39a received within one end 43a of said plain length of tube, and the second arm portion 39b received within the other end 43b of the tube; the clamping arrangement 23b clamps said one tube end 43a to said first arm portion 39a, and clamps said other tube end 43b to the second arm portion 39b.

The shaft 31 has first and second pulleys 45a, 45b, as illustrated in FIG. 2, respectively located inwards from the ends of the shaft.

A spring arrangement is connected between the jointed first and second parts 11, 13, being, in the example, first and second helical extension springs so connected by means of lengths, as 47, of filamentous material. The spring arrangement is such as, in the absence of air muscle actuation to exert a moment between the joint parts 11, 13, the spring arrangement being such as to provide compensation for effects of force, such, for example, as gravity, acting in opposition to force exerted by said spring arrangement. The provision of a spring arrangement as mentioned enables the use of an endless muscle 15 of power and, hence, size, which might not suffice in the absence of the spring arrangement.

The joint second part 13 has a second hinge axis A2-A2, being the longitudinal axis of a second shaft 49 orthogonal to the hinge axis A1-A1. A pulley 51, rotatable about the hinge axis A2-A2 is mounted on the shaft 49, and the space within the endless tubular braiding 17 and between the beam members 27a, 27b, is occupied in part, at least, by two further air muscles 53a, 53b, these having individual tubular braidings, and, within the tubular braidings, resiliently expansible tubes respectively end-stopped at first and second headers (not shown); and tubular braiding end portions 57a, 57b, respectively, of the two muscles 53a, 53b, are connected to one another by a length of tendon-representing filamentous material 59 extending tautly around the pulley 51 from one tubular braiding end portion 57a to the other 57b by way of the pulleys 45a, 45b.

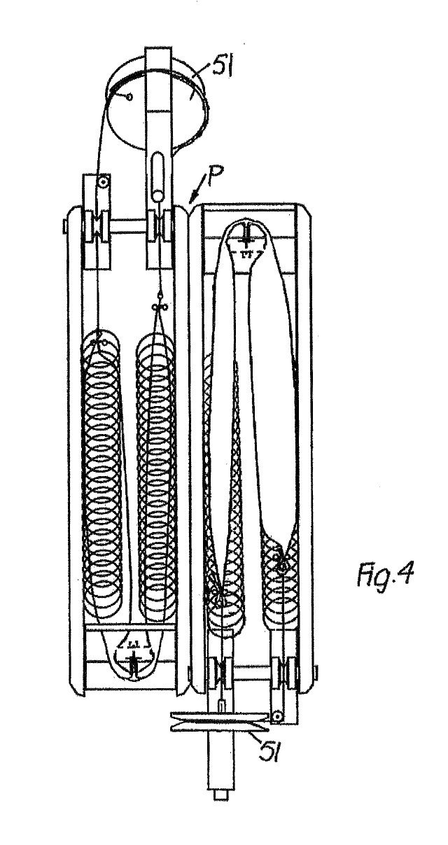

FIG. 4 depicts a musculo-skeletal joint combination first and second joints, each as previously described, the joint first parts 11 of said first and second joints being united at a common interface position P but with the joint first parts 11 of the joints orientated through 180 degrees with respect to one another. The common interface position P may be provided by the face to face contact between said first and second joints of beam members 11a of joint first parts 11. Alternatively, the joint first parts 11 of the first and second joints may share a common beam member 11a, this constituting the interface between the first and second joints.

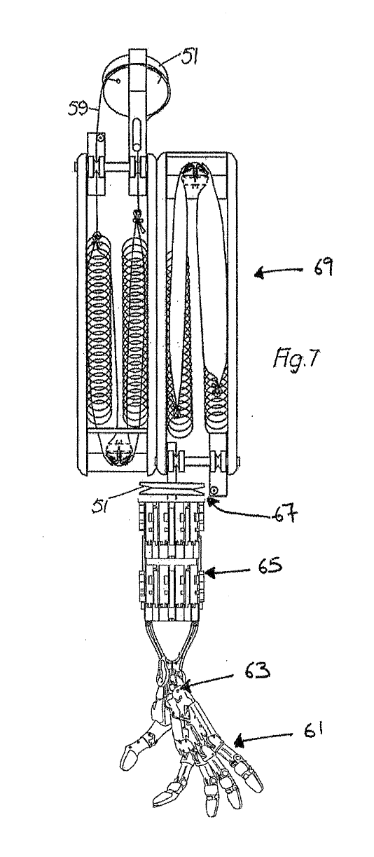

FIG. 7 depicts a robotic hand/arm configuration which comprises an air muscle driven humerus representing part 69 adapted to be coupled for angular motion with respect to a torso representing part; an electric actuator driven fore arm representing part 65 coupled for angular motion with respect to said humerus representing part 69 at an elbow representing joint 67; a hand representing part 61 coupled to said fore arm representing part 65 at a wrist representing joint 63; and filamentous material coupling the said wrist 63 and the finger representing joints of said hand representing part 61 variously to the several electric actuators of said fore arm representing part 65. As may be seen the configuration incorporates a jointed structure combination as previously described, the combination being coupled to the forearm representing part at the pulley of one of the jointed structure of the combination.

FIG. 7 illustrates an electric actuated fore arm 65 and hand 61. However, any other robotic hand or gripper of any given actuation that's within the same size envelope could be coupled for angular motion with respect to said humerus representing part 69 at the joint 67.

The invention has been described with particular illustrative embodiments. It is to be understood that the invention is not limited to the above-described embodiments and that various changes and modifications may be made by those of ordinary skill in the art without departing from the scope of the invention.

1-43. (canceled)

44. A robotic musculoskeletal jointed structure comprising:
(a) first and second joint parts coupled together for relative angular movement about a hinge axis therebetween;
(b) an air muscle;
(c) spaced first and second attachment sites respectively located at said joint first and second parts, and about which a tubular braiding, at least, of said air muscle extends to form an endless loop;
(d) first and second attachment means respectively located at said first and second air muscle spaced attachment sites, said first attachment means being such as to secure said tubular braiding against lengthwise movement thereof with respect to said joint first part at said first attachment site, and said second attachment means being such as to secure said tubular braiding against lengthwise movement thereof with respect to said joint second part at said second attachment site, the endless tubular braiding being thereby partitioned into first and second tubular braiding segments contiguous with one another at both said attachment sites; and,
(e) air duct means, being means whereby air may independently be admitted to, or evacuated from, each of said resiliently expansible air muscle tubular parts; and in which:
(f) said joint parts, the location therebetween of said axis, the locations of said first and second attachment sites and of said first and second tubular braiding attachment means thereat, and the positional inter-relationship between all of these, are such that change in tubular braiding length arising from variation in girth of the resiliently expansible tubular parts under change in air pressure in said air muscle tubular parts, or either of them, gives rise to a corresponding angular relative displacement between said joint first and second parts about said axis.

45. The jointed structure of claim 44, further comprising:
an endless, resiliently expansible tube housed within said endless tubular braiding; and
first and second clamping arrangements which effect sealing closures of said endless tube at the locations of the attachment means by which said tubular braiding is attached to said joint first and second parts, thereby to partition the endless tube such as to create first and second resiliently expansible tubular segments housed, respectively within said first and second tubular braiding segments with the first and second air compartments respectively defined thereby segregated against the migration of air therebetween.

46. The jointed structure of claim 44, in which said joint first part comprises:
first and second beam members;
means supporting said beam members such that these are held spaced apart with their longitudinal directions parallel to one another; and
bridging said space transversely, a shaft, the longitudinal axis of which constitutes said hinge axis.

47. The jointed structure of claim 46, in which said joint second part is attached to said shaft such as to be freely angularly movable with respect to said beam structure about said hinge axis.

48. The jointed structure of claim 47, in which said joint second part is rotatable with respect to said shaft.

49. The jointed structure of claim 44, in which said tubular braiding attachment sites, comprise first and second parts having first and second singly-substantially convexly-curved surfaces, respectively, around which said looped tubular braiding extends in contact with said surfaces.

50. The jointed structure of claim 49, in which said singly-convexly curved surfaces are of substantially cylindrical form.

51. The jointed structure of claim 45, in which said air duct means comprises a part having a central stem portion located in said joint second part within an opening located centrally along the single convexly-curved surface thereof in the direction of curvature thereof, and first and second arm portions extending, in said direction of curvature, from said stem portion at either side thereof, and said first and second air separate passages extend though said air duct part the first through said central stem portion and said first arm portion, the second through said stem portion and said second arm portion.

52. The jointed structure of claim 51, in which said air duct part is a unitary part.

53. The jointed structure of claim 51, in which said endless tube comprises a length of tube and said air duct means, the air duct means having said first arm portion thereof received within one end of said tube, and said second arm portion received within the other end of the said tube; and said second clamping arrangement comprises a first and second clamping devices, said first clamping device clamping said one tube end to said first arm portion, and the second clamping device clamping said other tube end to said second arm portion

54. The jointed structure of claims 46, in which said shaft has first and second collar portions respectively located inwards from the ends thereof.

55. The jointed structure of claim 54, in which said collar portions are each circumferentially grooved.

56. The jointed structure of claim 49, in which said tubular braiding is such as to extend with a portion of its length located around the singly convexly curved surface of said second attachment part, the tubular braiding being there, at least, of a width less than the width of said surface.

57. The jointed structure of claim 49, in which said tubular braiding is such as to extend with a portion of its length located around the singly convexly curved surface of said second attachment part, the tubular braiding being there, at least, of a width not greater than the spacing between said collar portions.

58. The jointed structure of claim 44, further comprising a spring arrangement connected between said first and second joint parts, said spring arrangement being such as to provide compensation for effects of movement between said joints parts under force acting in opposition to force exerted by said spring arrangement.

59. The jointed structure of claim 58, in which said spring arrangement comprises extension spring means.

60. The jointed structure of claim 58, in which said spring arrangement comprises a multiplicity of spring elements.

61. The jointed structure of claim 46, where said joint second part has a second hinge axis, being the longitudinal axis of a second shaft and being contained in a plane other than that in which the first hereinbefore mentioned hinge axis is contained; and further comprising:
pulley means mounted on said second shaft, being pulley means rotatable about said second hinge axis; and in which:
a central space within said endless tubular braiding is occupied, at least in part, by two further air muscles comprising individual tubular braidings and, within said tubular braidings, resiliently expansible tubes end-stopped at headers; and,
tubular braiding end portions of said two further air muscles are connected to one another by filamentous material extending tautly around said pulley means from one sheath end portion to the other.

62. The jointed structure of claim 61, wherein said joint first parts of said first and second joints being united at a common interface position with said joint first parts orientated through 180 degrees with respect to one another.

63. The jointed structure of claim 62 in which said common interface position is provided by the face to face contact between said first and second jointed structures at surfaces of said beam structures of said joints.

64. The jointed structure of claim 63 in which said first and second jointed structures have share a common beam member which constitutes said common interface between said joints.

65. A robotic hand/arm configuration which comprises an air muscle driven humerus-representing part adapted to be coupled for angular motion with respect to a torso-representing body part; an electric actuator driven fore-arm representing part coupled for angular motion with respect to said humerus-representing element; a hand representing part coupled to said fore-arm representing part at a wrist-representing joint; and filamentous material coupling the said wrist and the finger-representing joints of said hand-representing part variously to the several electric actuators of said fore-arm representing part.

66. The configuration of claim 65, in which said torso-representing part, humerus-representing part, and forearm-representing part are coupled as aforesaid by a musculo-skeletal jointed structure combination as described in the last preceding paragraph.

67. The hand/arm configuration as claimed in claim 60 in which said air muscle driven humerus-representing part comprises a jointed structure combination.

68. A fluid actuated muscle comprising:
a continuous expandable tube comprising a first chamber and a second chamber;
chamber defining devices defining the first chamber and the second chamber, such that fluid cannot be transferred between the first chamber and the second chamber; and
a fluid inlet/outlet device configured to enable fluid inlet/outlet to/from the first chamber and fluid inlet/outlet to/from the second chamber.

69. The fluid actuated muscle of claim 68, further comprising a braided layer surrounding the expandable tube.

70. The fluid actuated muscle of claims 69, wherein the braided layer comprises a lattice of interconnected flexible monofilament with low elasticity strands.

71. The fluid actuated muscle of claims 69, wherein radial expansion of the braided layer results in contraction of the length of the braided layer.

72. The fluid actuated muscle of claim 68, wherein at least one of the chamber defining devices comprises the fluid inlet/outlet device.

73. The fluid actuated muscle of claim 68, wherein the fluid inlet/outlet device comprises a curved surface, and wherein the expandable tube follows the curvature of at least a portion of the curved surface.

74. The fluid actuated muscle of claim 68, wherein the chamber defining devices comprise a curved surface, and wherein the expandable tube follows the curvature of at least a portion of the curved surface.

75. The fluid actuated muscle of claim 68, wherein the chamber defining devices comprise a clamp.

76. The fluid actuated muscle of claim 68, wherein the expandable tube comprises an elastomeric material.

77. The fluid actuated muscle of claim 68, wherein the expandable tube comprises natural rubber.

78. The fluid actuated muscle of claim 68, wherein the fluid is air.

79. The fluid actuated muscle of claim 68, wherein the fluid inlet/outlet device comprises a first fluid inlet/outlet configured to enable fluid inlet/outlet to/from the first chamber and a second fluid inlet/outlet configured to enable fluid inlet/outlet to/from the second chamber.

80. A robotic limb comprising a fluid actuated muscle comprising:
a continuous expandable tube comprising a first chamber and a second chamber;
chamber defining devices defining the first chamber and the second chamber, such that fluid cannot be transferred between the first chamber and the second chamber; and
a fluid inlet/outlet device configured to enable fluid inlet/outlet to/from the first chamber and fluid inlet/outlet to/from the second chamber.

81. The robotic limb of claim 80, further comprising a braided layer surrounding the expandable tube.

82. The robotic limb of claims 81, wherein the braided layer comprises a lattice of interconnected flexible monofilament with low elasticity strands.

83. The robotic limb of claims 81, wherein radial expansion of the braided layer results in contraction of the length of the braided layer.

84. The robotic limb of claim 80, wherein at least one of the chamber defining devices comprises the fluid inlet/outlet device.

85. The robotic limb of claim 80, wherein the fluid inlet/outlet device comprises a curved surface, and wherein the expandable tube follows the curvature of at least a portion of the curved surface.

86. The robotic limb of claim 80, wherein the chamber defining devices comprise a curved surface, and wherein the expandable tube follows the curvature of at least a portion of the curved surface.

87. The robotic limb of claim 80, wherein the chamber defining devices comprise a clamp.

88. The robotic limb of claim 80, wherein the expandable tube comprises an elastomeric material.

89. The robotic limb of claim 80, wherein the expandable tube comprises natural rubber.

90. The robotic limb of claim 80, wherein the fluid is air.

91. The robotic limb of claim 80, wherein the fluid inlet/outlet device comprises a first fluid inlet/outlet configured to enable fluid inlet/outlet to/from the first chamber and a second fluid inlet/outlet configured to enable fluid inlet/outlet to/from the second chamber.
